(19) United States
(12) Patent Application Publication
(10) Pub. No.: US 2026/0127629 A1
(43) Pub. Date: May 7, 2026

(54) MWM INTEGRATION WITH CARD USAGE-BASED REWARDS

(71) Applicant: KwikClick, LLC, Murray, UT (US)

(72) Inventor: Fred Cooper, Farmington, UT (US)

(21) Appl. No.: 18/133,390

(22) Filed: Apr. 11, 2023

Related U.S. Application Data
(60) Provisional application No. 63/330,203, filed on Apr. 12, 2022.

(51) Int. Cl. G06Q 30/0214

(52) U.S. Cl. CPC G06Q 30/0214

(57) ABSTRACT

Systems and methods are provided for integrating existing card usage-based rewards systems with multi-wave user structures and third-party rewards. Unique card numbers associated with the rewards systems can also be used to keep track of the user tree structure including multiple levels of upline members and downline members associated with a particular user, which may result in identifying which upline users are responsible for the user's online activities and which downline users' online activities may be attributed to this particular user.

### CROSS-REFERENCE TO RELATED APPLICATION

The present application claims the priority benefit of U.S. provisional application No. 63/330,203 filed Apr. 12, 2022, the disclosure of which is incorporated herein by reference.

### BACKGROUND OF THE INVENTION

### Field of the Invention

The present disclosure is generally related to multi-wave user structures. More specifically, the present disclosure is directed to integration multi-wave user structures with card usage-based rewards.

### Description of the Related Art

A multi-wave marketing (MWM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multi-wave marketing.

Multi-wave marketing is a legitimate business sales strategy. One problem is that the MWM is organized as a pyramid tree. However, pyramid “schemes” that use money from new recruits to pay people at the top rather than those who perform the work are illegal. These pyramid schemes involve taking advantage of people by pretending to be engaged in legitimate multi-wave or network marketing. You can spot pyramid schemes by their greater focus on recruitment rather than product sales.

One issue in determining the legitimacy of a multi-wave marketing company is whether it sells its products primarily to consumers or to its members, who must recruit new members to buy their products. The company is likely a legitimate multi-wave marketer if it sells its products primarily to consumers. If it sells its products primarily to its members, it could be an illegal pyramid scheme.

Although each MWM company dictates its own specific financial compensation plan for the payout of any earnings to their respective participants, the common feature found across all MWMs is that the compensation plans theoretically pays out to participants only from two potential revenue streams. The first is paid out from sales commissions made by the participants directly to their retail customers. The second is paid out from commissions based upon the wholesale purchases made by other distributors below the participant who have recruited those other participants into the MWM; in the organizational hierarchy of MWMs, these participants are referred to as one's downline distributors.

Therefore, MWM salespeople (distributors) are expected to sell products directly to end-user retail consumers through relationship referrals and word-of-mouth marketing. Still, most importantly, they are incentivized to recruit others to join the company's distribution chain as fellow salespeople so that these can become downline distributors.

Currently, to join a MWM, there is an initiation fee, which is a barrier against those who just wish to refer a single product they like. Current MWM systems also do not take full advantage of the Internet and fail to integrate with online user workflows, thereby leading to inefficient, repetitive, and/or otherwise poor online experiences. Also, current MWM systems do not incorporate incentivizing users of MWM systems by offering a dynamic rewards structure (e.g., tree structure). Conversely, there is no current MWM system that allows for discounts, coupons, or other rewards to be reincorporated into a multi-wave marketing system so as to incentivize users to engage with certain websites and further promote further engagement by other users.

Conversely, presently available systems for managing rewards systems based on online usage of digital or other card codes (e.g., rewards card, membership card, credit card) by different online users having complex, multi-level relationships. Inability to track such relationships prevents existing systems from being able to identify which users may be responsible for certain online activities or actions of other users across the different websites.

Nor do most online rewards systems track multiple levels of upline or downline users that may have contributed to another user's online activities, leading to the inability to treat such online actions (e.g., taken at a website or via web application) differently based on such relationships.

There is therefore a need in the art for improved system and methods of integrating multi-wave user structures with card usage-based rewards.

### SUMMARY OF THE CLAIMED INVENTION

Systems and methods are provided for integrating existing card usage-based rewards systems with multi-wave user structures and third-party rewards. Unique card numbers associated with the rewards systems can also be used to keep track of the user tree structure including multiple levels of upline members and downline members associated with a particular user, which may result in identifying which upline users are responsible for the user's online activities and which downline users' online activities may be attributed to this particular user.

In exemplary embodiments, a user device of a first user interacts with a website registered with an administration network computer. The user may then then automatically be added to a dynamic user structure maintained by the administration network computer. The administration network generates a code that may be based on or associated with a unique rewards identifier of the user (e.g., card number or user identifier of existing rewards system).

The code may be embedded into a link distributed online to user devices of contacts and other online users. One such contact or other user may engage in the same online activity at the same website, and in the process, uses the code as part of the online activity. The second user may also automatically be added or incorporated into the user structure as downline from the first user (who is upline from the second user). The administration network generates a different code associated with the second user and any upline users (e.g., the first user and any of their upline user(s)). Rewards may include points, awards, badges, vouchers, coupons, discounts, gift, commissions, etc., that may be tracked within the dynamic user structure in real-time with the online interaction occurring at linked websites associated with codes. Online interactions may include various selections or actions taken at a designated website, and such online interactions may be associated with a code embedded in a link used to access the designated website.

### BRIEF DESCRIPTIONS OF THE DRAWINGS

FIG. 1 illustrates a multi-wave marketing system according to an embodiment.

FIG. 2 illustrates a base module according to an embodiment.

FIG. 3 illustrates a calculation module according to an embodiment.

FIG. 4 illustrates a commission module according to an embodiment.

FIG. 5 illustrates an advertising module according to an embodiment.

FIG. 6 illustrates an admin database according to an embodiment.

FIG. 7 illustrates a vendor module according to an embodiment.

FIG. 8 illustrates a compensation database according to an embodiment.

FIG. 9 illustrates a code database according to an embodiment.

FIG. 10 illustrates a coupon module according to an embodiment.

FIG. 11 illustrates a coupon database according to an embodiment.

FIG. 12 illustrates a CC sign-up module according to an embodiment.

FIG. 13 illustrates a CC database according to an embodiment.

FIG. 14 illustrates a Kwikclick module according to an embodiment.

FIG. 15 illustrates a user database according to an embodiment.

FIG. 16 illustrates a downline module according to an embodiment.

FIG. 17 illustrates a 3rd party base module according to an embodiment.

FIG. 18 illustrates an admin module according to an embodiment.

FIG. 19 illustrates a discount module according to an embodiment.

FIG. 20 illustrates a 3rd party database according to an embodiment.

### DETAILED DESCRIPTION

Systems and methods are provided for integrating existing card usage-based rewards systems with multi-wave user structures and third-party rewards. Unique card numbers associated with the rewards systems can also be used to keep track of the user tree structure including multiple levels of upline members and downline members associated with a particular user, which may result in identifying which upline users are responsible for the user's online activities and which downline users' online activities may be attributed to this particular user.

Definitions “MWM Distributor” refers to the non-salaried workforce selling the company's products or services, while the earnings of the participants are derived from a pyramid-shaped or binary compensation commission system. “MWM Distributors” can be integrated into this system or method in many elements or steps of this invention.

“Distributor Contact List or followers” refers to the recruits or followers on social media that a distributor has secured to participant in their downline. “Distributor Contact List or followers” can be integrated into this system or method in many elements or steps of this invention.

“Upline” refers to the MWM distributors that recruits work for as salespeople to sell the products or services. “Upline” can be integrated into this system or method in many elements or steps of this invention.

“Downline” refers to the recruits that the MWM distributors can secure as participants in the MWM system. “Downline” can be integrated into this system or method in many elements or steps of this invention.

A “Product” refers to an article or substance manufactured or refined for sale. “Products” can be integrated into this system or method in many elements or steps of this invention.

A “Service” refers to a system supplying a public need such as transport, communications, or utilities such as electricity or water. For example, a “Service” may be an act of dealing with a customer in a store, restaurant, or hotel by taking their orders, showing, or selling them goods. Additionally, a “Service” may be work that someone does or time spent working for an organization or a business that offers a particular type of help or work. A “Service” can be integrated into this system or method in many elements or steps of this invention.

“Network Marking” refers to a business model that depends on person-to-person sales by independent representatives, often working from home. For example, a “Network Marketing” business may require independent representatives to build a network of business partners or salespeople to assist with lead generation and closing sales. “Network Marketing” can be integrated into this system or method in many elements or steps of this invention.

A “Commission” refers to a payment to someone who sells goods that is directly related to the amount sold or a system that uses such payments. A “Commission” can be integrated into this system or method in many elements or steps of this invention.

“Commission Plan” refers to the decay rate of the commissions provided to the MWM system from the discount offered by the 3rd party. The 3rd party also selects the decay rate to calculate the commissions offered to the first purchaser and the percentage offered to the downline participants. “Commission Plan” can be integrated into this system or method in many elements or steps of this invention.

“Commission Tree” refers to the payment structure in which commissions are given out. “Commission Tree” can be integrated into this system or method in many elements or steps of this invention.

“Advertise to the Network” refers to the advertisement provided to the MWM system from the 3rd party offering a product, good, or service. “Advertise to the Network” can be integrated into this system or method in many elements or steps of this invention.

“Advertising Link” refers to a link that directs a consumer to a product, service, or good. “Advertising Link” can be integrated into this system or method in many elements or steps of this invention.

“Social media plug-ins for enhanced marketing” refer to sharing content with other people through social media platforms, for example, a share or like button. “Social media plug-ins for enhanced marketing” can be integrated into this system or method in many elements or steps of this invention.

“Local media (video's, pictures, text, sounds/haptics, other local media (online product descriptions for enhanced marketing” refer to the various types of media, such as photos, videos, etc. “Local media (video's, pictures, text, sounds/haptics, other local media) online product descriptions for enhanced marketing” can be integrated into this system or method in many elements or steps of this invention.

“End of life of MWM tree” refers to the end of the MWM tree in which further participants in the MWM will not receive a commission, the commission tree starts up again, or the commission tree is restructured in some form. “End of life of MWM tree” can be integrated into this system or method in many elements or steps of this invention.

“Rating and recommendation modules” refer to modules in which a company, entity, or person provides ratings and/or recommendations for products, goods, or services. “Rating and recommendation modules” can be integrated into this system or method in many elements or steps of this invention.

“Existing MWM system” refer to currently existing or established companies that use the sales strategies to encourage existing distributors to recruit new distributors who are paid a percentage of their recruits' sales. “Existing MWM system” can be integrated into this system or method in many elements or steps of this invention.

“As seen on TV sales” refer to a generic nameplate for products advertised on television in the United States for direct-response mail-order through a toll-free telephone number. “As seen on TV sales” can be integrated into this system or method in many elements or steps of this invention.

A “Franchise” refers to an authorization granted by a government or company to an individual or group enabling them to carry out specified commercial activities, e.g., providing a broadcasting service or acting as an agent for a company's products. “Franchise” can be integrated into this system or method in many elements or steps of this invention.

“Product consumables” refer to goods by individuals and businesses that must be replaced regularly because they wear out or are used up. “Product consumables” can be integrated into this system or method in many elements or steps of this invention.

“Service networks” refer to a collection of people and information brought together on the internet to provide a specific service or achieve a common business objective, such as Angie's List. “Service networks” can be integrated into this system or method in many elements or steps of this invention.

“Downlines tree goes across country boundaries” refers to the ability to pay out commissions for an MWM tree even though the participants in the MWM tree may not reside in the same country. In this case, the commissions would need to be calculated for the appropriate exchange rate to ensure participants are paid in their country's currency in the correct amount. “Downlines tree goes across country boundaries” can be integrated into this system or method in many elements or steps of this invention.

“ID Enrollment” refers to a participant enrolling in an MWM product tree through an ID, which is unique to each participant in the MWM system. “ID Enrollment” can be integrated into this system or method in many elements or steps of this invention.

“Track profits and payments” refers to the MWM system tracking the profits of the MWM and tracking the payments or commissions paid out to participants. “Track profits and payments” can be integrated into this system or method in many elements or steps of this invention.

“Track taxes” refers to tracking the commissions provided to participants for tax purposes. “Track taxes” can be integrated into this system or method in many elements or steps of this invention.

“Communicate events with downlines and uplines” refers to advertising events to participants in an MWM system. “Communicate events with downlines and uplines” can be integrated into this system or method in many elements or steps of this invention.

“Product returns” refer to a process in which a customer or consumer takes previously purchased product, merchandise, or goods back to the retailer, and in turn, receive a refund in the original form of payment, exchange for another item (identical or different), or store credit. “Product returns” can be integrated into this system or method in many elements or steps of this invention.

“Product discounts” refer to a reduced price or something being sold at a price lower than that item is normally sold for. It is a reduction to a basic price for a good or service. “Product Discounts” can be integrated into this system or method in many elements or steps of this invention.

A “Credit card system” refers to a system that allows cardholders to borrow funds with which to pay for goods and services with the condition that the cardholders pay back the borrowed funds, plus interest, as well as any additional agreed-upon charges. A “Credit card system” can be integrated into this system or method in many elements or steps of this invention.

An “E-commerce sale” refers to sales of goods and services where the business takes place over the internet, an extranet, Electronic Data Interchange (EDI), or other online systems. Payment may or may not be made online. Business in this context is defined as an order placed by the buyer or price and terms of sale negotiated. An “E-commerce sale” can be integrated into this system or method in many elements or steps of this invention.

An “E-commerce shopping cart” refers to software used in E-commerce to assist visitors in making purchases online. Upon checkout, the software calculates the order's total, including shipping and handling, taxes, and other parameters the site owner has previously set. An “E-commerce shopping cart” can be integrated into this system or method in many elements or steps of this invention.

A “Retailer” refers to a person or business that sells goods to the public in relatively small quantities for use or consumption rather than for resale. A “Retailer” can be integrated into this system or method in many elements or steps of this invention.

“Dynamic incentives and rewards for a product” refer to incentives or rewards that are continuously updated for a product. “Dynamic incentives and rewards for product” can be integrated into this system or method in many elements or steps of this invention.

“Suggestive selling” refers to a sales technique where an employee asks a customer if they would like to include an additional purchase or recommends a product that might suit the client. “Suggestive selling” can be integrated into this system or method in many elements or steps of this invention.

“Data security” refers to the process of protecting data from unauthorized access and data corruption throughout its lifecycle. “Data security” includes data encryption, tokenization, and key management practices that protect data across all applications and platforms. “Data security” can be integrated into this system or method in many elements or steps of this invention.

“Banking referral” refers to a structured flow of collecting and organizing referrals for banks. Businesses who have been unsuccessful in a credit application process with a bank will be asked for their permission to have their financial information passed to designated finance platforms that can contact the business in a regulated time frame. “Banking referral” can be integrated into this system or method in many elements or steps of this invention.

“Marketing materials” refer to a means of marketing, advertising, or promotional materials developed by or for a license (or subject to licensee's approval) that promote the sale of the licensed product, including but not limited to television, radio, and online advertising, point of sale materials (e.g., posters, counter-cards), packaging advertising, print media and all audio or video media. “Marketing materials” can be integrated into this system or method in many elements or steps of this invention.

A “Lottery” refers to a process or thing whose success or outcome is governed by chance. A means of raising money by selling number tickets and giving prizes to the number holders drawn randomly. A “Lottery” can be integrated into this system or method in many elements or steps of this invention.

“Freelancers” refer to a person who works as a writer, designer, performer, or the like, selling work or services by the hour, day, job, etc., rather than working on a regular salary basis for one employer. “Freelancers” can be integrated into this system or method in many elements or steps of this invention.

“MWM Algorithm” refers to the calculation performed using the compensation decay rate to calculate the commissions for downline participants. “MWM Algorithm” can be integrated into this system or method in many elements or steps of this invention.

“Large Box Stores” refer to a physically large retail establishment. Usually, part of a chain of stores offers a variety of products to its customers. The term sometimes refers, by extension, to the company that operates the store and may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance. “Large Box Stores” can be integrated into this system or method in many elements or steps of this invention.

“Airline sky miles” refer to a loyalty program offered by airlines and/or credit cards. Typically, consumers accumulate a set amount of miles based on how much is spent on a ticket or a credit card and are also known as frequent flyer miles or travel points. “Airline sky miles” can be integrated into this system or method in many elements or steps of this invention.

“Social media aggregators” refers to a tool allowing a person to collate posts and updates from many different social media feeds. It creates an organized view of social posts on a specific topic and displays user-generated content on live social walls. “Social media aggregators” can be integrated into this system or method in many elements or steps of this invention.

“Connect App Store” refers to connecting the app store to an MWM system. “Connect App Store” can be integrated into this system or method in many elements or steps of this invention.

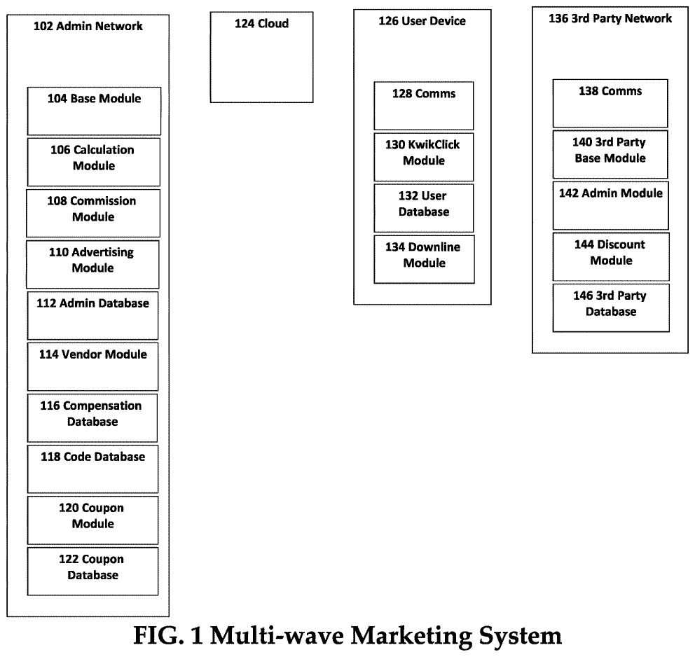

FIG. 1 is a Multi-Wave Marketing (MWM) System. This system comprises of an Admin Network which includes a Base Module 102, Calculation Module 106, Commission Module 108, Advertising Module 110, Admin Database 112, Vendor Module 114, Compensation Database 116, and a Code Database 118, where the Admin Network is the MWM system to accept sellers (3rd parties) and where a “single product tree” MWM method is formed, comprising the steps of, providing at least one product, and providing an MWM system with a seller's commission structure, and providing at least one seller of a product with its associated commission structure, and providing a plurality of buyers/distributors, and allowing the at least one first seller to enroll at least one product to the MWM system, and allowing at least a first buyer/distributor to purchase the at least one product, and allowing the at least the first buyer/distributor to advertise the at least one product to other potential buyers/distributors, and allowing at least a second buyer/distributor to buy the advertised product. Further, the seller sets a commission structure for a product, enrolls the product into the MWM system, allows the first, second and so on purchasers/distributors to purchase and then advertise the product, and allows the purchasers/distributors to receive a commission based upon the seller's product commission structure.

An Admin Network Base Module 104, which connects to the 3rd Party Base Module 146, initiates the Vendor Module 114 and initiates the Calculation Module 106. The 3rd Party Network Base Module 136 interacts with the sellers, and the Admin Network Vendor Module 114 is loaded on the seller's computers system.

An Admin Network Calculation Module 106, which is initiated by the Admin Network Base Module 104, extracts the discount received from the 3rd Party Module 136 as well as the compensation plan (e.g., the compensation plan can include a decay rate or commission structure so that each downline gets less and less commission) to determine the commissions for the MWM tree and stores the data in the Admin Network Compensation Database 116.

An Admin Network Commission Module 108 is continuously polling for the user data (e.g., the user is the product purchaser/distributor) from the 3rd Party Discount Module 140. Once it receives the data, the Admin Network Commission Module 108 uses the data stored in the Admin Network Compensation Database 116 to determine the downline and upline commissions for the other users (e.g., product purchasers/distributors) within the MWM tree.

The Admin Network Commission Module 108 then initiates the Admin Network Advertising Module 110.

An Admin Network Advertising Module 110, which is initiated by the Admin Network Commission Module 108, determines the user's sphere of influence or contact list to provide the user's potential downline purchasers/distributors with a link and a code for the potential downline purchasers/distributors to become part of the MWM tree.

An Admin Network Admin Database 112, which is created through the Admin Network Vendor Module 114 (e.g., seller of a product), contains the data received from various 3rd Parties (e.g., various sellers) that are part of the MWM, the data may contain an item ID, description of the item, the original cost of the item, the discount for the item, the cost of the item with the discount, the compensation plan decay rate and a link to the item.

An Admin Network Vendor (those selling products) Module 114, which is initiated by the Admin Network Base Module 104, receives the data from the 3rd Party Network 142, stores the data in the Admin Network Admin Database 112, creates a link for the item and sends the link back to the 3rd Party Network 142 and returns to the Admin Network Base Module 104.

An Admin Network Compensation Database 116, created through the Admin Network Calculation Module 106, contains the various commissions for the different product purchasers/distributors.

An Admin Network Code Database 118 contains the codes given to the product purchasers/distributors for the product purchasers/distributors to pass the code to their potential purchasers/distributors to advertise or promote the item the user has purchased.

An Admin Network Coupon Module 120, which receives a coupon code from the Admin Network Commission Module 108, searches the Admin Network Coupon Database 122 for the coupon code, then sends the associated commission alteration data to the Admin Network Commission Module 108.

An Admin Network Coupon Database 122 contains a list of coupon codes and the associated changes to a commission structure.

An Admin Network CC sign-up Module 124 may allow users to sign up for a credit card. The user may provide the information necessary and be granted a credit card if approved. The CC App may facilitate this process.

An Admin Network CC database 126 which may contain information on credit cards such as the associated user, current balance, credit limit, and coupons pre-loaded onto the card.

The Cloud 128 or communication network may be wired or wireless. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A User (product purchasers/distributors) Device 130 such as a laptop, smartphone, tablet, computer, or smart speaker.

The User Device Comms 132 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A User Device KwikClick Module 134, which connects to the 3rd Party Network 142, allows a purchaser/distributor to select an item and the associated link, determines if the purchaser/distributor entered a code, and sends the link and code, if available, to the 3rd Party Network 142.

A User Device User Database 136 contains the user's (product purchasers/distributors) followers (sphere of influence) as well as the follower's contact information in order for them to receive commissions on their purchases.

A User Device Downline Module 138 is continuously polling to receive the code and link from the Admin Network Advertising Module 110 to allow the purchaser/distributor to pass the code and link to the user's followers stored in the User Device User Database 136.

A User Device CC App 140 may be a program or application that allows users to manage their credit cards. This may include signing up for a card, paying the outstanding balance, loading coupons or referral codes onto a card, etc.

A 3rd Party Network 142 is the various 3rd Parties, such as retail stores, services, or e-commerce sites, that offer items to users at a discount to use MWM.

The 3rd Party Network Comms 144 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A 3rd Party Base Module 146, which initiates the 3rd Party Admin Module 138, continuously polls for the user to select a link, receives the purchaser/distributor data, and initiates the 3rd Party Network Discount Module 150.

A 3rd Party Network Admin Module 148, which is initiated from the 3rd Party Network Base Module 136, connects to the Admin Network 102, sends the data for the items to be purchased, receives a link from the Admin Network 102, stores the link in the 3rd Party Network Database 142 and returns to the 3rd Party Network Base Module 136.

A 3rd Party Network Discount Module 150, which is initiated from the 3rd Party Base Module 146, extracts the link and compares it to the 3rd Party Network 3rd Party Database 152 to extract the corresponding discount for the selected item, the discount is applied to the user order, and it is determined if the user entered a code or not, the order is processed, and the process returns to the 3rd Party Network Base Module 136.

A 3rd Party Network 3rd Party Database 152 which contains information about the item the 3rd party selects to offer at a discount for the Admin Network 102.

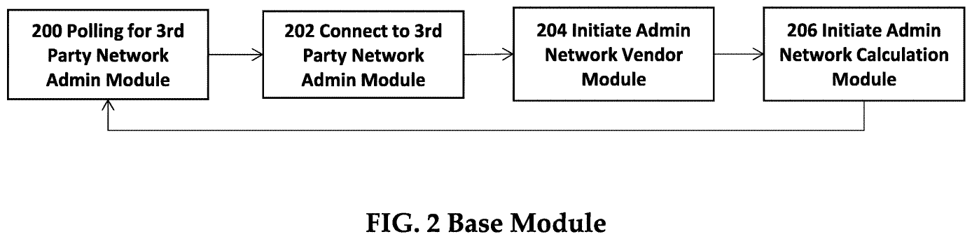

Functioning of the “Base Module” will now be explained with reference to FIG. 2.

One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 2 displays the “Admin Network Base Module.” The process begins with the Admin Network Base Module 104 continuously polling the 3rd Party Network Admin Module 148 (sellers of products) at step 200. The Admin Network Base Module 104 connects to the 3rd Party Network Admin Module 148 (sellers of products) at step 202. Once the Admin Network Base Module 104 connects to the 3rd Party Network Admin Module 148, the Admin Network Base Module 104 initiates the Admin Network Vendor Module 114 at step 204. Then the Admin Network Base Module 104 initiates the Admin Network Calculation Module 106, and the process returns to step 200, at step 206.

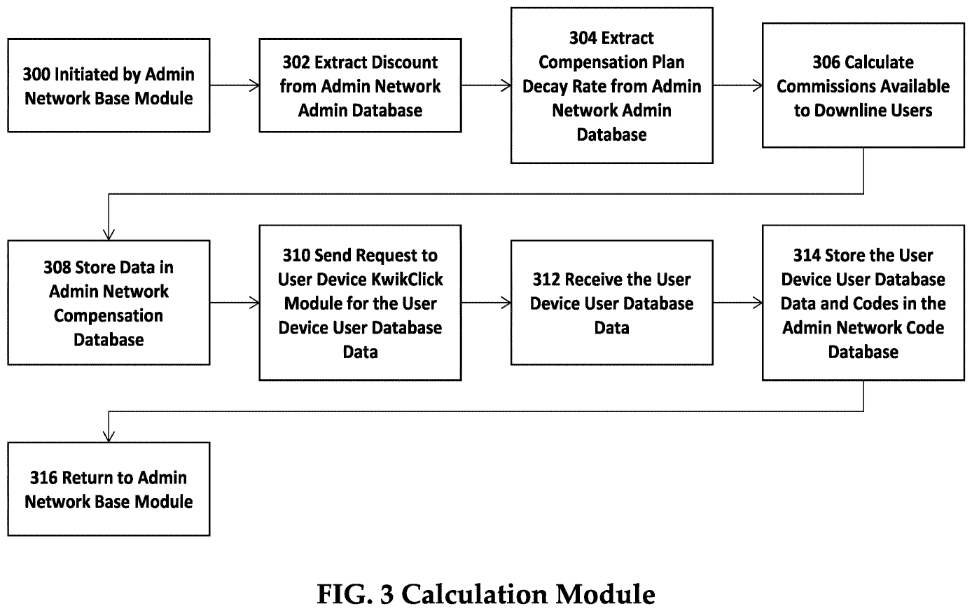

Functioning of the “Calculation Module” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 3 displays a process and steps performed by the “Admin Network Calculation Module.” The process begins with the Admin Network Base Module 104 initiating the Admin Network Calculation Module 106 at step 300. The Admin Network Calculation Module 106 extracts the discount from the Admin Network Admin Database 112, which is received from the 3rd Party Network 142, at step 302. Then the Admin Network Calculation Module 106 extracts the compensation plan decay rate from the Admin Network Admin Database 112, at step 304.

The Admin Network Calculation Module 106 determines the commissions available to the downline users or the user's followers who purchased the item.

In some embodiments, the commissions may be calculated by using the discount on the item and providing 50% of the discount to the first participant and then the remaining amount of the discount for the downline users at a 50% decay rate. For example, if the first user purchased an item that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device KwikClick Module 134 for the data stored in the User Device User Database 136, at step 310. Then the Admin Network Calculation Module 106 receives the User Device User Database 136 data from the User Device KwikClick Module 134, at step 312. The Admin Network Calculation Module 106 stores the received data and the code data in the Admin Network Code Database 118, at step 314. The Admin Network Calculation Module 106 then returns to the Admin Network Base Module 104, at step 316.

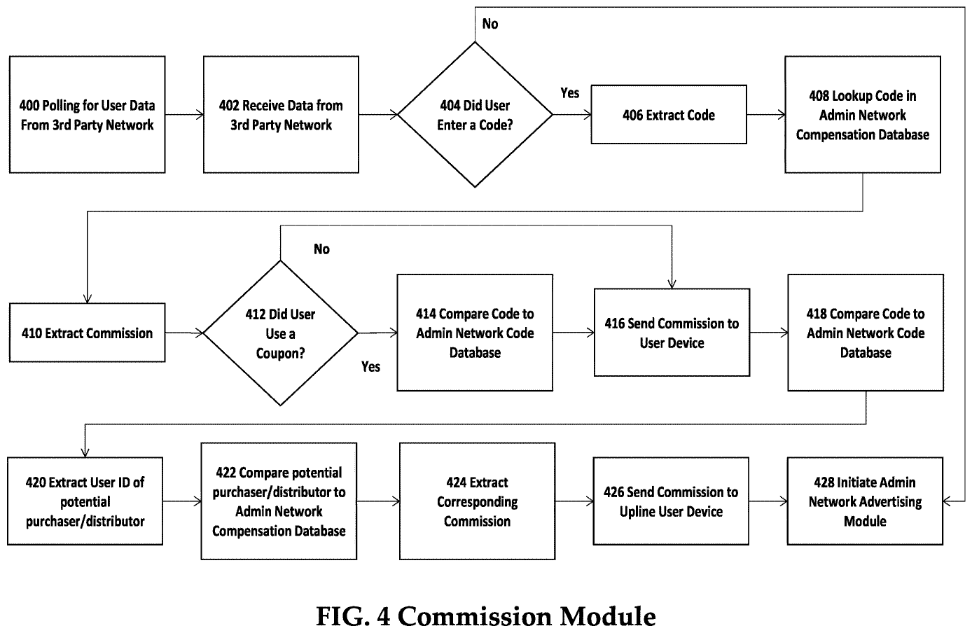

Functioning of the “Commission Module” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 4 displays the “Admin Network Commission Module.” The process begins with the Admin Network Commission Module 108 continuously polling for the user data from the 3rd Party Network Discount Module 150, at step 400. The Admin Network Commission Module 108 receives the user data from the 3rd Party Network Discount Module 150, at step 402. Then the Admin Network Commission Module 108 determines if the user entered a code at step 404. If the user did enter a code, the Admin Network Commission Module 108 extracts the code the user entered at step 406. The extracted code is then looked up in the Admin Network Compensation Database 116, which contains the various commissions for the different sphere of influence or potential product purchasers/distributors levels and the associated code for each of the different spheres of influence levels at step 408. Then the Admin Network Commission Module 108 extracts the corresponding commission for the code looked up in the Admin Network Compensation Database 116, at step 410. The Admin Network Commission Module 108 determines if the user used a coupon. The user data associated with the purchase may contain a coupon code or other data that identifies the use of a coupon. If the user did not use a coupon, the Admin Network Commission Module 108 may skip to step 416, at step 412. The Admin Network Commission Module 108 sends the coupon data to the Admin Network Coupon Module 120 and polls for a response. The response from the Admin Network Coupon Module 120 may contain alterations to the commission plan, which the Admin Network Commission Module 108 may then apply to the extracted commission at step 414. The Admin Network Commission Module 108 sends the commission to the user (purchaser/distributor) at step 416. Then the Admin Network Commission Module 108 compares the extracted code to the Admin Network Code Database 118, which contains the list of users and the code sent to the user's followers, at step 418. The Admin Network Commission Module 108 extracts the user ID and sphere of influence or potential purchaser/distributor using the extracted code at step 420.

Then the Admin Network Commission Module 108 compares the extracted sphere of influence or potential purchaser/distributor to the Admin Network Compensation Database 116, at step 422. The Admin Network Commission Module 108 uses the extracted sphere of influence to extract the corresponding commission from the Admin Network Compensation Database 116, at step 424. The Admin Network Commission Module 108 sends the commission to the upline user at step 426. If the user did not enter a code, the Admin Network Commission Module 108 initiates the Admin Network Advertising Module 110, at step 428.

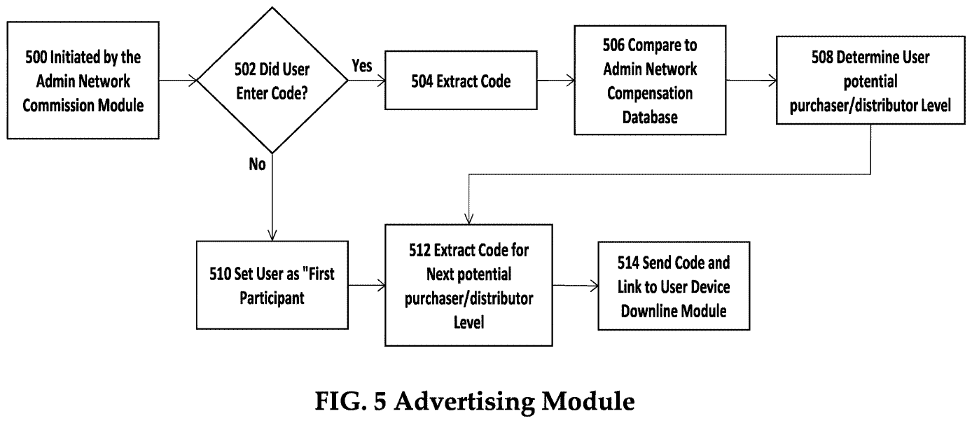

Functioning of the “Advertising Module” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 5. displays the “Admin Network Advertising Module.” The process begins with the Admin Network Commission Module 108, initiating the Admin Network Advertising Module 110 at step 500. The Admin Network Advertising Module 110 determines if the user entered a code at step 502. If it is determined that the user entered a code, the code is extracted at step 504. The Admin Network Advertising Module 110 compares the extracted code to the Admin Network Compensation Database 116, at step 506. The Admin Network Advertising Module 110 determines the user's sphere of influence level at step 508. If it is determined that the user did not enter a code, then the Admin Network Advertising Module 110 sets the user as the “First Participant” at step 510. Then the Admin Network Advertising Module 110 extracts the code for the next sphere of influence level or potential purchaser/distributor to provide the user's followers with a code that would allow them to join the Multi-wave Marketing tree, at step 512. The Admin Network Advertising Module 110 sends code and the link to the item to the User Device Downline Module 138, at step 514.

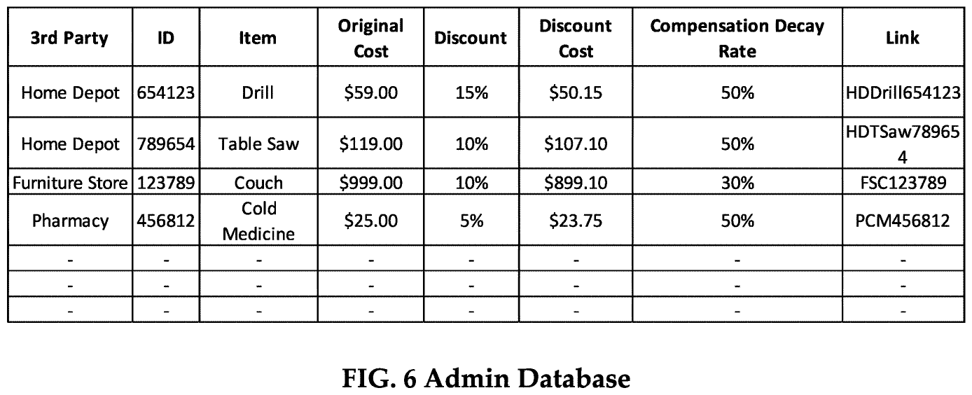

Functioning of the “Admin Database” will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 6 displays the Admin Network Admin Database 112, which is created through the Admin Network Vendor Module 114. The Admin Network Vendor Module 114 receives the item data from the 3rd Party Network, creates a link for the item, stores the data in the Admin Network Admin Database 112, and sends the created link back to the 3rd Party Network. The Admin Network Admin Database 112 contains the data collected from various 3rd Parties enrolled in the MWM System. The Admin Network Admin Database 112 contains the name of the 3rd party, the ID for the item, a description of the item, the original cost of the item, the discount provided by the 3rd party, the cost of the item with the discount, the compensation decay rate or how the downline commissions are calculated, and the link to the item.

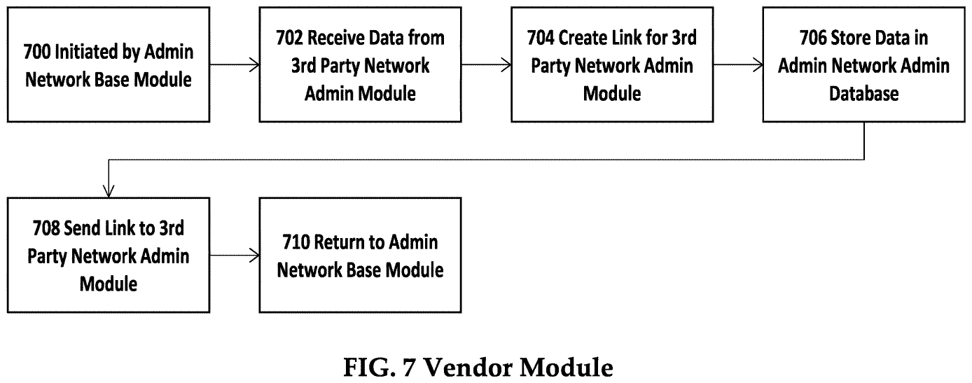

Functioning of the “Vendor Module” will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 7. displays the “Admin Network Vendor Module.” The process begins with the Admin Network Base Module 104 initiating the Admin Network Vendor Module 114 at step 700. The Admin Network Vendor Module 114 receives the data from the 3rd Party Network Admin Module 148, which may include the item to be enrolled in the MWM system, the original cost of the item, the discount provided by the 3rd party, the cost of the item with the discount, the compensation plan decay rate, etc., at step 702. Then the Admin Network Vendor Module 114 creates a link for the item for the 3rd Party Network Admin Module 148. A vendor is a seller of a product, such as a retailer, at step 704. The Admin Network Vendor Module 114 stores the received data and the created link in the Admin Network Admin Database 112, at step 706. The Admin Network Vendor Module 114 sends the link to the 3rd Party Network Admin Module 148 at step 708. The Admin Network Vendor Module 114 returns to the Admin Network Base Module 104 at step 710.

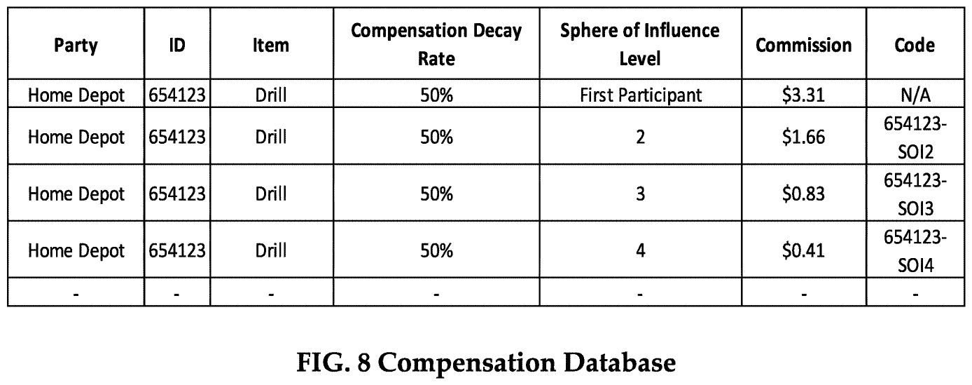

Functioning of the “Compensation Database” will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 8. displays the Admin Network Compensation Database 116, which is created through the Admin Network Calculation Module 106. The Admin Network Calculation Module 106 extracts the discount and the compensation plan decay rate to calculate the downline commissions for additional users, and the various sphere of influence levels are stored in the Admin Network Compensation Database 116. The Admin Network Compensation Database 116 contains the 3rd party, the ID for the item, the item, the compensation plan decay rate, the various sphere of influence levels, the commission for each sphere of influence level, and the code to be used by the user's followers to enroll in the MWM system.

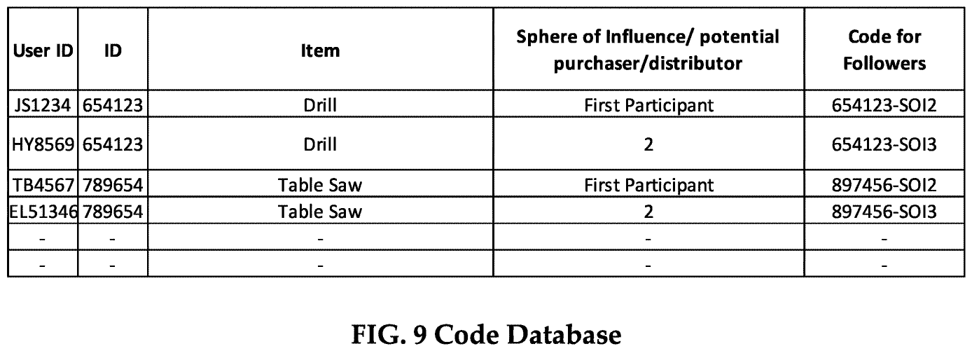

Functioning of the “Code Database” will now be explained with reference to FIG. 9. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 9 displays the Admin Network Code Database 118, which is used to determine the sphere of influence of the purchaser/distributor from the code that was used when a purchaser/distributor purchased a product or item from a 3rd Party. The Admin Network Code Database 118 contains a User ID, ID, Item, Sphere of Influence/potential purchaser/distributor, and Code for Followers.

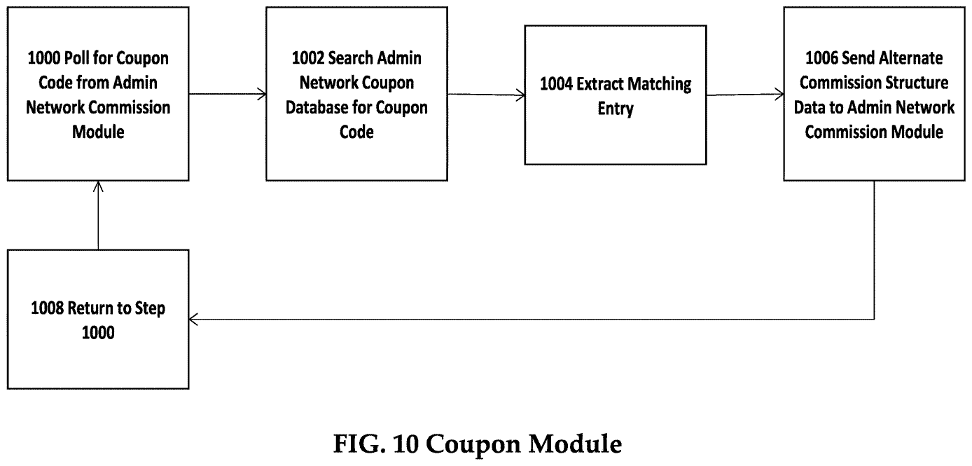

Functioning of the “Coupon Module” will now be explained with reference to FIG. 10. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 10 displays the “Admin Network Coupon Module.” The process begins with the Admin Network Coupon Module 120 polling for a coupon code from the Admin Network Commission Module 108. The coupon code may correspond to a coupon used by a user to purchase a product registered with the network at step 1000. The Admin Network Coupon Module 120 may search the Admin Network Coupon Database 122 for the received coupon code at step 1002. Next, the Admin Network Coupon Module 120 may extract the entry that matches the received coupon code at step 1004. Next, the Admin Network Coupon Module 120 sends the extracted data, which contains alternate commission structure information, to the Admin Network Commission Module 108 at step 1006. The Admin Network Coupon Module 120 returns to polling for a coupon code from the Admin Network Commission Module 108, at step 1008.

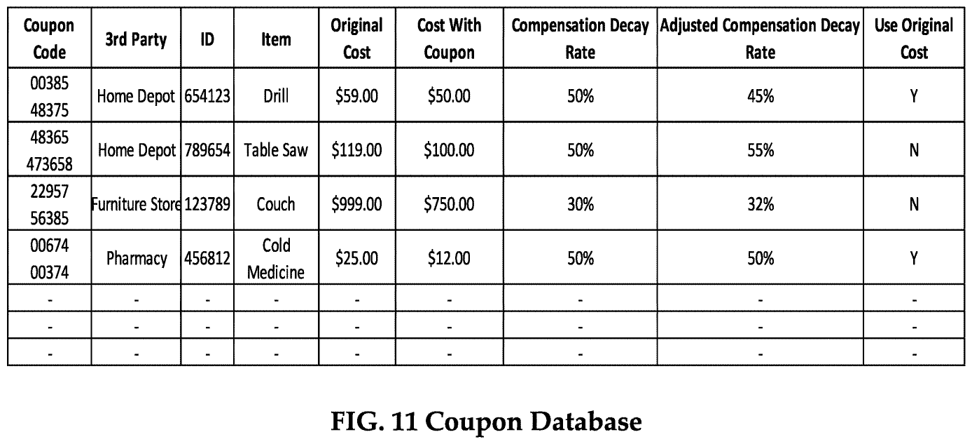

Functioning of the “Coupon Database” will now be explained with reference to FIG. 11. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 11 displays the “Admin Network Coupon Database.” The Admin Network Coupon Database 122 may contain a list of coupon codes and the associated changes to a commission structure. For example, the database may contain identifiers for the product the coupon code is associated with, such as an item ID or item name. In addition, the database may contain the original decay rate for commission and an altered rate. The database may also indicate whether the original cost of the product or the discounted cost with the coupon should be used to calculate commission.

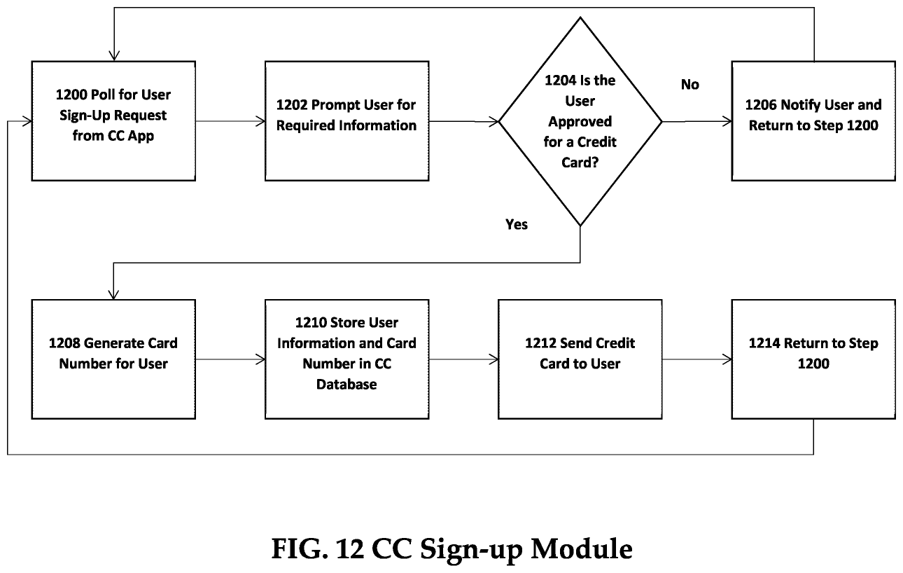

Functioning of the “CC Sign-up Module” will now be explained with reference to FIG. 12. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 12 displays the “CC Sign-up Module.” The process begins with the Admin Network CC Sign-up Module 124 polling or a user sign-up request from the User Device CC App 140. The request may be initiated by a user selecting, for example, a “sign-up for a credit card” option from within the application, at step 1200. The Admin Network CC Sign-up Module 124 may prompt the user for the information required to sign-up for a credit card. This information may include information that identifies the user to the system, such as a user ID.

This information may include information required to issue a credit card, such as personal identifying information, address, social security number, date of birth, etc. The Admin Network CC Sign-up Module 124 may poll for the completed information. The User Device CC App 140 may verify that the user has correctly entered the information before sending it to the Admin Network 102, at step 1202. The Admin Network CC Sign-up Module 124 may determine if the user is approved for a credit card. The approval process may require the user to meet requirements set by an administrator of the Administration Network 102, requirements set by a credit card clearinghouse, requirements set by other interested parties, or any combination of requirements. For example, a user may need a high enough credit score before being approved for a credit card. This process may take time, and the user may be prompted for additional information if more information is needed at step 1204. If the user is not approved, the Admin Network CC Sign-up Module 124 may notify the user and return to step 1200. The notification may include reasons why the user was not improved and may inform the user of how they may be approved or appeal the denial. The user may be barred from requesting another credit card for some amount of time or until they submit different information, at step 1206. If the user is approved, the Admin Network CC Sign-up Module 124 may generate a card number for the user. Credit card numbers often take the form of a 16-digit number in 4-digit groups such as “1111 2222 3333 4444”, at step 1208. The Admin Network CC Sign-up Module 124 may store the user information and generated card number in the Admin Network CC Database 126. The user may now pre-load coupon codes and referral codes onto the card. The user may now make purchases with the card at step 1210. The Admin Network CC Sign-up Module 124 may send the credit card to the user. This may involve processes that include the physical creation of the card, generating a CVC code and expiration date, loading data onto the magnetic stripe on the card, or any other steps to initiating a credit card known in the art. The mailing of the physical card may be handled automatically by this or another module or manually, at step 1212. The Admin Network CC Sign-up Module 124 may return to step 1200 and poll for another sign-up request at step 1214.

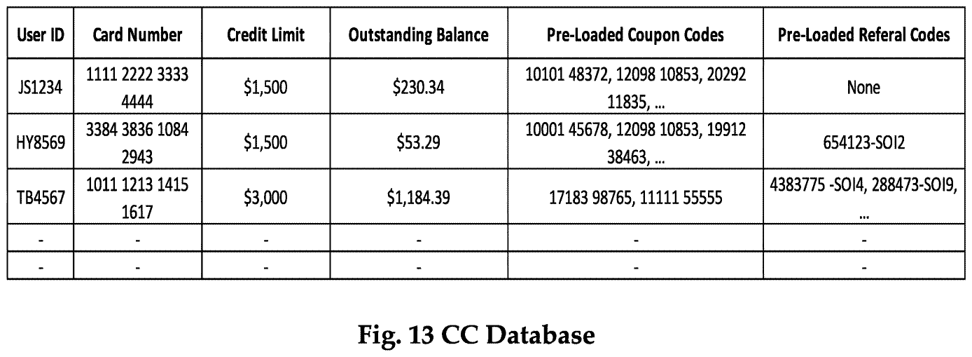

Functioning of the “CC Database” will now be explained with reference to FIG. 13. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 13 displays the “CC Database.” The Admin Network CC Database 126 may contain data that facilitates the use of a credit card by a system user. For example, the database may contain a credit card number, an associated user ID, the balance on the credit card, and the credit limit. In addition, the database may contain pre-loaded coupon codes, which may be applied to purchases with the credit card if the coupon is applicable. These coupon codes may be UPC barcode numbers, discount codes, or any other code which the 3rd Party Network 142 or another vendor may recognize as conferring some discount or offer. The database may also contain referral codes from the code database, which may also be recognized by the 3rd Party Network 142. Coupon and referral codes may be pre-loaded onto the credit card through the User Device CC App 140. In addition, referral codes may be automatically loaded onto the credit card if a user clicks a referral link, and the user can be identified at step 1300.

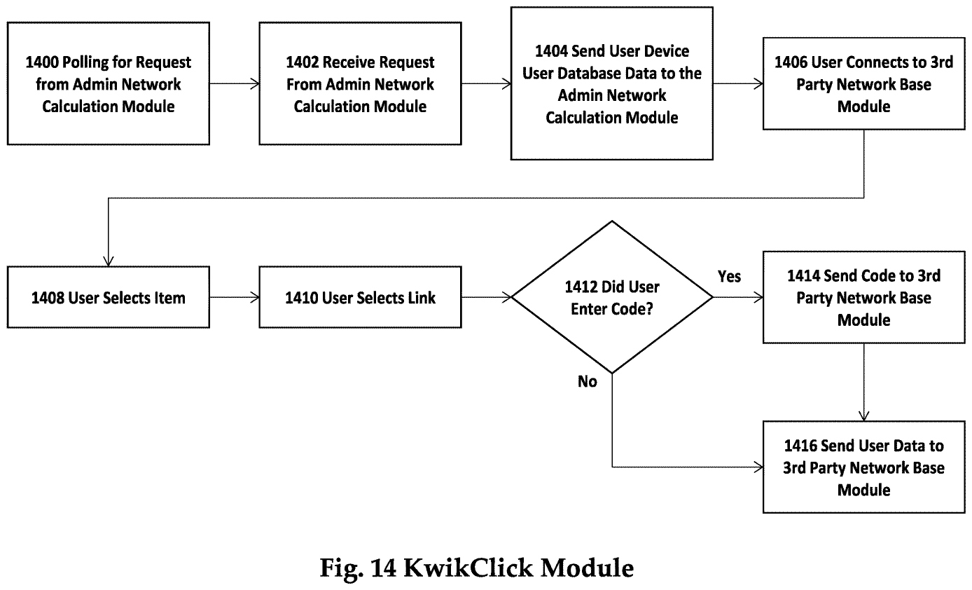

Functioning of the “KwikClick Module” will now be explained with reference to FIG. 14. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 14 displays the “User Device KwikClick Module.” The process begins with the User Device KwikClick Module 134 continuously polling for a request from the Admin Network Calculation Module 106 for the User Device User Database 136 data, at step 1400. The User Device KwikClick Module 134 receives a request from the Admin Network Calculation Module 106 for the User Device User Database 136 data, at step 1402. Then the User Device KwikClick Module 134 sends the User Device User Database 136 data to the Admin Network Calculation Module 106, at step 1404. The User Device KwikClick Module 134 connects to the 3rd Party Network Base Module 136, at step 1406. Then the user selects an item from the 3rd Party Network 142, at step 1408. The user selects the link from the 3rd Party Network 142, at step 1010. Then the User Device KwikClick Module 134 determines if the user entered a code; if not, the process continues to step 1410, at step 1412. If it is determined that the user entered a code, the User Device KwikClick Module 134 sends the code to the 3rd Party Network Base Module 136, at step 1414. The User Device KwikClick Module 134 sends the user data to the 3rd Party Network Base Module 136. In some embodiments, the user data may be data to purchase the item such as name, address, billing information, etc., at step 1416.

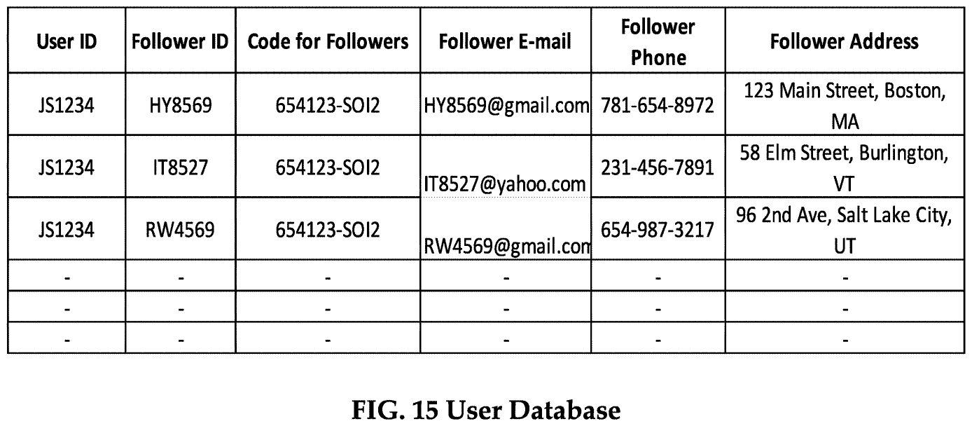

Functioning of the “User Database” will now be explained with reference to FIG. 15. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 15 displays the User Device User Database 136, which contains the user's followers and followers' information. The User Device User Database 136 contains the user's ID, the follower's user's ID, the code provided to the followers, the follower's e-mail address, the follower's phone number, the follower's address. In some embodiments, the User Device User Database 136 may contain the follower's social media information such as Twitter, Instagram, Facebook, etc. In some embodiments, the User Device User Database 136 may contain payment information such as bank accounts, credit card information, PayPal, Venmo, etc., element 1100.

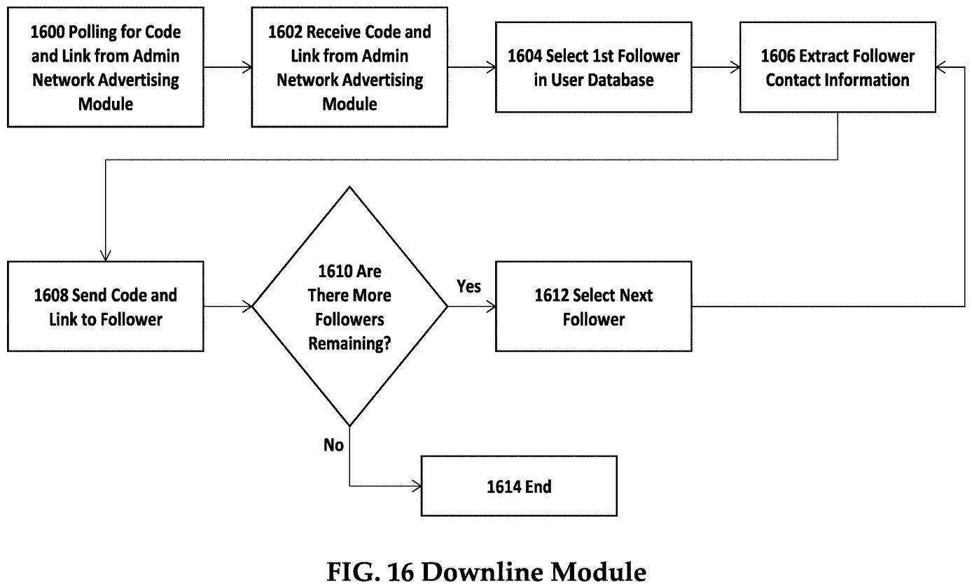

Functioning of the “Downline Module” will now be explained with reference to FIG. 16. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 16 displays the “Downline Module.” The process begins with the User Device Downline Module 138 continuously polling for the code and the link from the Admin Network Advertising Module 110, at step 1600. The User Device Downline Module 138 receives the code and the link from the Admin Network Advertising Module 110, at step 1602. The User Device Downline Module 138 selects the first follower in the User Device User Database 136 at step 1604. The User Device Downline Module 138 extracts the follower's contact information stored in the User Device User Database 136, at step 1606. Then the User Device Downline Module 138 sends the code and link to the follower's contact information. In some embodiments, the code and link may be shared on social media sites, such as Twitter, Instagram, Facebook, etc., for the user's followers to receive the code and link at step 1608. The User Device Downline Module 138 determines if more followers remain in the User Device User Database 136, at step 1610. If it is determined that there are more followers stored in the User Device User Database, the User Device Downline Module 138 selects the next user stored in the User Device User Database 136, and the process returns to step 1206 at step 1612. If the User Device Downline Module 138 determines that no more followers remain in the User Device User Database 136, then the process ends at step 1614.

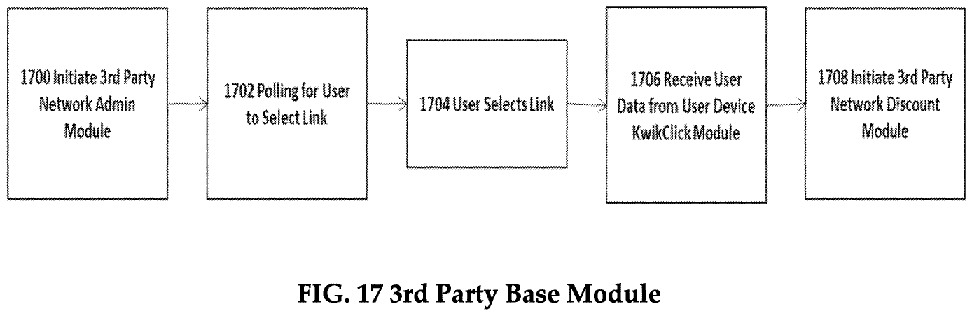

Functioning of the “3rd Party Base Module” will now be explained with reference to FIG. 17. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 17 displays the “3rd Party Network 3rd Party Base Module”. The process begins with the 3rd Party Network Base Module 136 initiating the 3rd Party Network Admin Module 148, at step 1700. Then the 3rd Party Network Base Module 136 continuously polls for the user to select the link at step 1702. The user selects the link on the 3rd Party Network 142, at step 1704. Then the 3rd Party Network Base Module 136 receives the user data from the User Device KwikClick Module 134. In some embodiments, the user data may be data to purchase the item such as name, address, billing information, etc., at step 1706. Then the 3rd Party Network Base Module 136 initiates the 3rd Party Network Discount Module 150, at step 1708.

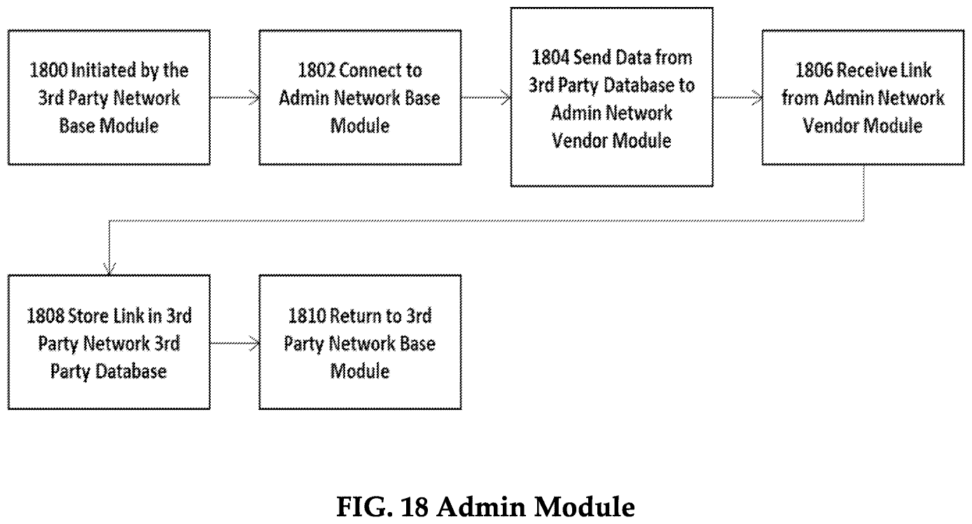

Functioning of the “Admin Module” will now be explained with reference to FIG. 18. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 18 displays the “3rd Party Network Admin Module”. The process begins with the 3rd Party Network Admin Module 148 being initiated by the 3rd Party Network Base Module 136, at step 1800. The 3rd Party Network Admin Module 148 connects to the Admin Network 102 at step 1802. Then the 3rd Party Network Admin Module 148 sends the 3rd Party Network 3rd Party Database 152 to the Admin Network Vendor Module 114, at step 1804. The 3rd Party Network Admin Module 148 receives the link for the item from the Admin Network Vendor Module 114 at step 1806. Then the 3rd Party Network Admin Module 148 stores the link in the 3rd Party Network 3rd Party Database 152, at step 1808. Then the 3rd Party Network Admin Module 148 returns to the 3rd Party Network Base Module 136, at step 1810.

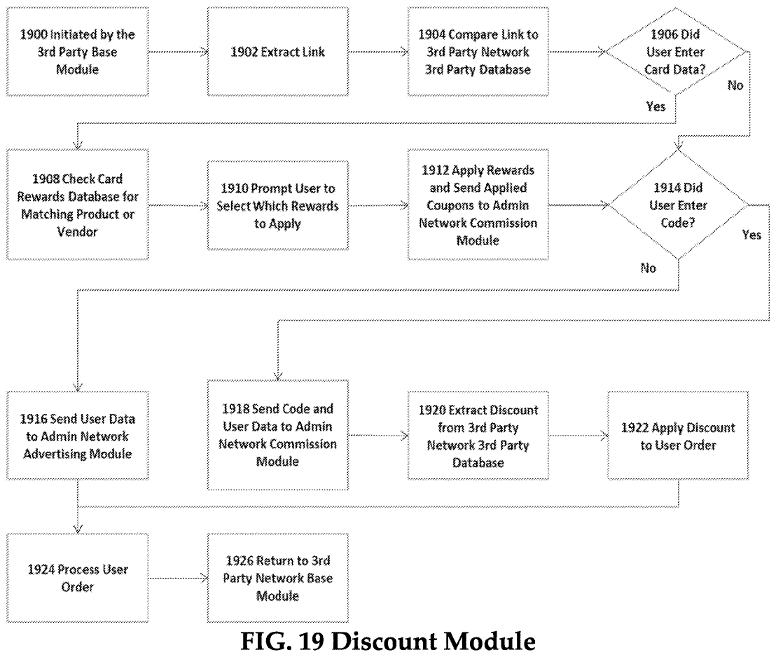

FIG. 19 displays the “Discount Module.” The process begins with the 3rd Party Network Base Module 136 initiating the 3rd Party Network Discount Module 150, at step 1900. The 3rd Party Network Discount Module 150 extracts the link received from the user through the process described in the 3rd Party Network Base Module 136, at step 1902. Then the 3rd Party Network Discount Module 150 compares the extracted link to the 3rd Party Network 3rd Party Database 152, at step 1904. The 3rd Party Network Discount Module 150 determines if the user has entered card data. Card data is any data that may be associated with a card, such as a credit card number, card expiration date, CVC, data stored on the magnetic stripe of a card, or any other data that the user may submit to associate the purchase of the product with a card. If the user has not entered card data, the 3rd Party Network Discount Module 150 may skip to step 714 at step 1906. Then the 3rd Party Network Discount Module 150 connects to the Card Network 148 and accesses the Card Network Card Rewards Database 152. The 3rd Party Network Discount Module 150 searches for rewards in the database that would be applied to either the product being purchased, the vendor from which the product is being purchased, or both. Some rewards may require that the product is purchased from only some vendors, some rewards may apply to the product despite the vendor, and some rewards may be applied to any purchase made from the vendor, at step 1908. The 3rd Party Network Discount Module 150 prompts the user to select which rewards to apply to this purchase. For example, the user may need to choose between a 10% discount or $5 off the purchase. The 3rd Party Network Discount Module 150 may default to whichever reward or combination of rewards gives the largest discount. This step may be skipped if none of the rewards are exclusive at step 1910. Then the 3rd Party Network Discount Module 150 applies the rewards to the purchase and sends coupon data to the Admin Network Commission Module 108. Not all rewards may be coupons, but any reward may be considered a coupon. The 3rd Party Network Discount Module 150 may only send the coupon data to the Admin Network Commission Module 108 following completion of the purchase. Once the reward has been claimed, it may be erased from, or marked used in, the Card Network Card Rewards Database 152, at step 1912. The 3rd Party Network Discount Module 150 determines if the user entered a code. A user may choose between using card rewards or entering a code if the two discounts are exclusive. The user may not need to enter the code manually if the code is pre-loaded on the credit card, at step 1914. If it is determined that the user did not enter a code, the 3rd Party Network Discount Module 150 sends the user data to the Admin Network Advertising Module 110, at step 1916. If it is determined that the user entered a code, the 3rd Party Network Discount Module 150 sends the code and the user data to the Admin Network Commission Module 108, at step 1918. The 3rd Party Network Discount Module 150 extracts the corresponding discount using the extracted link from the 3rd Party Network 3rd Party Database 152, at step 1920. Then the 3rd Party Network Discount Module 150 applies the extracted discount to the user's order, at step 1922. Then the 3rd Party Network Discount Module 150 processes the user's order at step 1924. Then the 3rd Party Network Discount Module 150 returns to the 3rd Party Network Base Module 136, at step 1926.

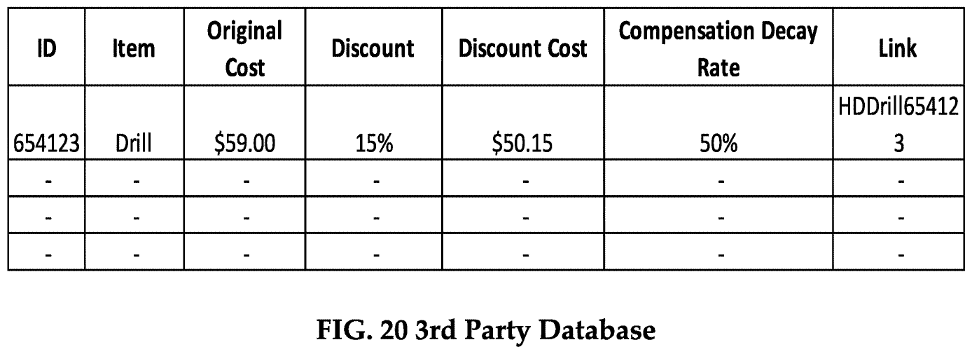

Functioning of the “3rd Party Database” will now be explained with reference to FIG. 20. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 20 displays the 3rd Party Network 3rd Party Database 152, which contains the information about the items enrolled in the MWM system and the link created by the Admin Network Vendor Module 114. The 3rd Party Network 3rd Party Database 152 contains the item ID, the item, the original cost of the item, the discount provided by the 3rd party for the item, the cost of the item with the discount, the compensation plan decay rate which the 3rd party enters, and the link received from the Admin Network Vendor Module 114.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for integrating multiwave user structures into rewards systems, the method comprising:
storing a first code in a database in memory, wherein the first code is associated with a card identifier of a first user;
receiving a request sent over a communication network from a user device using an online web application associated with a link having the first code embedded therein, the user device associated with a second user, wherein the request is associated with a card identifier of the second user;
identifying one or more upline users including the first user associated with the matching code in the database corresponding to the first code embedded in the link;
assigning one or more rewards to the first user based on being among the identified upline users, wherein the assigned rewards are stored in the database in association with the card identifier of the first user;
generating a second code to assign to the second user; and
updating the database to store the second code in association with the second user, wherein the second code is further associated with the at least one upline user and the card identifier of the second user.

2. The method of claim 1, further comprising storing a decay rate associated with the assigned rewards, whereby the decay rate decreases upline rewards by a predefined ratio.

3. The method of claim 1, further comprising storing one or more coupon codes in the database in association with the card identifier of the second user, and applying one of the coupon codes to the request.

4. The method of claim 3, further comprising changing a rewards schedule in response to the first coupon code being applied to the request.

5. The method of claim 4, wherein changing the rewards schedule includes changing an associated decay rate used for assigning the rewards.

6. The method of claim 3, further comprising:
determining whether the first coupon code is mutually exclusive with the first code; and
generating a prompt to the user device regarding a selection between the first coupon code and the first code when the first coupon code is determined to be mutually exclusive with the first code.

7. The method of claim 3, further comprising:
searching a rewards database to identify a set of the one or more rewards related to the request, wherein the rewards include one or more of rebates, redeemable points, and discounts associated with the card identifier of the second user;
determining whether the first coupon code is mutually exclusive with the set of rewards; and
generating a prompt to the user device regarding a selection between the first coupon code and the set of rewards when the first coupon code is mutually exclusive with the set of rewards.

8. The method of claim 3, further comprising erasing or marking as used the first coupon code after the first coupon code has been applied to another request from a user device of the first user.

9. The method of claim 1, further comprising:
signaling a third-party computer network to send the first code and information regarding the second user to an administrative computer network;
extracting a discount code that corresponds to the first code using the link as extracted from a database of the third-party computer network; and
applying a discount to the request in accordance with the discount code.

10. The method of claim 1, further comprising storing information associated with the card identifier in a computational data structure, the stored information including one or more of a user identity field, a card number field, a credit limit field, a pre-loaded coupon code field, and a pre-loaded referral code field.

11. A non-transitory, computer-readable storage medium, having embodied thereon instructions executable by a computer to perform a method for integrating multiwave user structures into rewards systems, the method comprising:
storing a first code in a database in memory, wherein the first code is associated with a card identifier of a first user;
receiving a request sent over a communication network from a user device using an online web application associated with a link having the first code embedded therein, the user device associated with a second user, wherein the request is associated with a card identifier of the second user;
identifying one or more upline users including the first user associated with the matching code in the database corresponding to the first code embedded in the link;
assigning one or more rewards to the first user based on being among the identified upline users, wherein the assigned rewards are stored in the database in association with the card identifier of the first user;
generating a second code to assign to the second user; and
updating the database to store the second code in association with the second user, wherein the second code is further associated with the at least one upline user and the card identifier of the second user.

12. The non-transitory computer-readable storage medium of claim 11, further comprising instructions executable to store a decay rate associated with the assigned rewards, whereby the decay rate decreases upline rewards by a predefined ratio.

13. The non-transitory computer-readable storage medium of claim 11, further comprising instructions executable to store one or more coupon codes in the database in association with the card identifier of the second user, and apply one of the coupon codes to the request.

14. The non-transitory computer-readable storage medium of claim 13, further comprising instructions executable to change a rewards schedule in response to the first coupon code being applied to the request.

15. The non-transitory computer-readable storage medium of claim 14, wherein changing the rewards schedule includes changing an associated decay rate used for assigning the rewards.

16. The non-transitory computer-readable storage medium of claim 13, further comprising instructions executable to:
determine whether the first coupon code is mutually exclusive with the first code; and
generate a prompt to the user device regarding a selection between the first coupon code and the first code when the first coupon code is determined to be mutually exclusive with the first code.

17. The non-transitory computer-readable storage medium of claim 13, further comprising instructions executable to:
search a rewards database to identify a set of the one or more rewards related to the request, wherein the rewards include one or more of rebates, redeemable points, and discounts associated with the card identifier of the second user;
determine whether the first coupon code is mutually exclusive with the set of rewards; and
generate a prompt to the user device regarding a selection between the first coupon code and the set of rewards when the first coupon code is mutually exclusive with the set of rewards.

18. The non-transitory computer-readable storage medium of claim 13, further comprising instructions executable to erase or mark as used the first coupon code after the first coupon code has been applied to another request from a user device of the first user.

19. The non-transitory computer-readable storage medium of claim 11, further comprising instructions executable to:
signal a third-party computer network to send the first code and information regarding the second user to an administrative computer network;
extract a discount code that corresponds to the first code using the link as extracted from a database of the third-party computer network; and
apply a discount to the request in accordance with the discount code.

20. The non-transitory computer-readable storage medium of claim 11, further comprising instructions executable to store information associated with the card identifier in a computational data structure, the stored information including one or more of a user identity field, a card number field, a credit limit field, a pre-loaded coupon code field, and a pre-loaded referral code field.
